(19) United States
(12) Patent Application Publication
(10) Pub. No.: US 2012/0319988 A1
(43) Pub. Date: Dec. 20, 2012

(54) SYSTEM AND METHOD FOR SENSOR DEVICE SIGNALING USING A POLARITY RESET INTERVAL

(75) Inventor: Adam SCHWARTZ, Santa Clara, CA (US)

(73) Assignee: SYNAPTICS INCORPORATED, Santa Clara, CA (US)

(21) Appl. No.: 13/161,267

(22) Filed: Jun. 15, 2011

(51) Int. Cl. G06F 3/044

(52) U.S. Cl. 345/174; 178/18.06

(57) ABSTRACT

A capacitive sensing method includes transmitting a first transmitter signal with a first transmitter electrode such that the first transmitter signal includes a first plurality of sensing cycles. A resulting signal is received with a receiver electrode, wherein the resulting signal comprises effects corresponding to the first transmitter signal. The polarity of each sensing cycle of the first plurality of sensing cycles corresponds to a respective bit within a bit sequence of a first spreading code, and each sensing cycle of the first plurality of sensing cycles comprises a measurement interval and a polarity reset interval.

### FIELD OF THE INVENTION

This invention generally relates to electronic devices, and more specifically relates to sensor devices.

### BACKGROUND OF THE INVENTION

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers).

Proximity sensor devices typically incorporate either profile sensors or image sensors. Profile sensors alternate between multiple axes (e.g., x and y), while image sensors scan multiple transmitter rows to produce a more detailed “image” associated with an input object. Because of its increased processor requirements, however, image sensors may exhibit undesirable frame rates, reduced signal-to-noise ratio, increased position jitter, and/or object misinterpretation. Accordingly, there is a need for improved image sensor systems and methods.

### BRIEF SUMMARY OF THE INVENTION

A processing system in accordance with one embodiment of the present invention includes transmitter module and receiver module. The transmitter module comprises transmitter circuitry and the transmitter module is configured to transmit a first transmitter signal with a first transmitter electrode, wherein the first transmitter signal comprises a first plurality of sensing cycles, the polarity of each sensing cycle of the first plurality of sensing cycles corresponds to a respective bit within a bit sequence of a first spreading code, and wherein each sensing cycle of the first plurality of sensing cycles comprises a measurement interval and a polarity reset interval. The receiver module comprises receiver circuitry and the receiver module is configured to receive a resulting signal with a receiver electrode, wherein the resulting signal comprises effects corresponding to the first transmitter signal.

A method of capacitive sensing in accordance with one embodiment of the present invention includes transmitting a first transmitter signal with a first transmitter electrode, the first transmitter signal comprising a first plurality of sensing cycles; and receiving a resulting signal with a receiver electrode, wherein the resulting signal comprises effects corresponding to the first transmitter signal. The polarity of each sensing cycle of the first plurality of sensing cycles corresponds to a respective bit within a bit sequence of a first spreading code, and each sensing cycle of the first plurality of sensing cycles comprises a measurement interval and a polarity reset interval.

A capacitive sensor device in accordance with one embodiment of the present invention includes a first transmitter electrode, a receiver electrode; and a processing system communicatively coupled to the first transmitter electrode and receiver electrode. The processing system is configured to transmit a first transmitter signal with the first transmitter electrode, wherein the first transmitter signal comprises a first plurality of sensing cycles, the polarity of each of the first plurality of sensing cycles corresponds to a respective bit within a bit sequence of a first spreading code, and each of the first plurality of sensing cycles comprises a measurement interval and a polarity reset interval. The processing system is further configured to receive a resulting signal with the receiver electrode, wherein the resulting signal comprises effects corresponding to the first transmitter signal.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary system that includes an input device in accordance with an embodiment of the invention;

FIG. 2 is a block diagram of sensing circuitry in accordance with an exemplary embodiment of the invention;

FIG. 3 is a conceptual block diagram depicting an exemplary embodiment of the invention;

FIG. 4 is a timing diagram depicting exemplary sampling and reset intervals in accordance with one embodiment of the invention; and

FIG. 5 is a timing diagram depicting exemplary sampling and reset intervals in accordance with an alternate embodiment of the invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary, or the following detailed description.

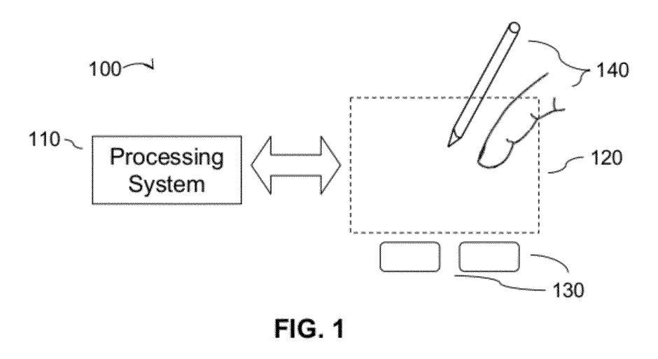

Various embodiments of the present invention provide input devices and methods that facilitate improved usability. FIG. 1 is a block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

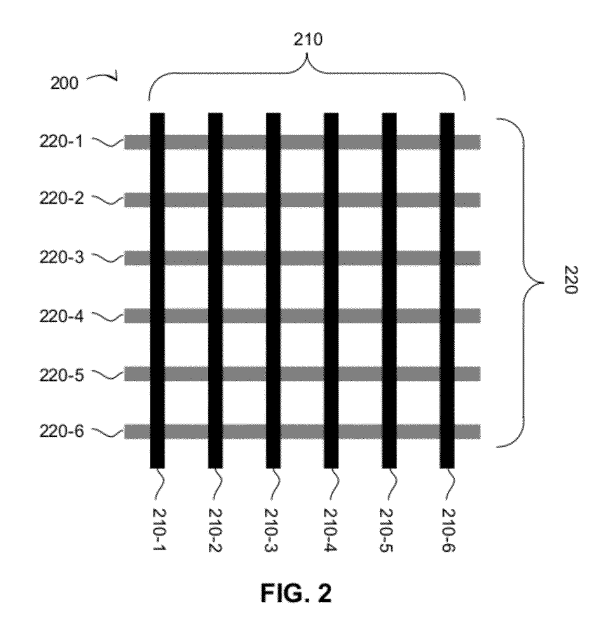

In this regard, FIG. 2 illustrates, conceptually, an exemplary set of capacitive sensor electrodes 200 configured to sense in a sensing region. For clarity of illustration and description, FIG. 2 shows a pattern of simple rectangles; however, it will be appreciated that the invention is not so limited, and that a variety of electrode patterns may be suitable in any particular embodiment. In one embodiment, sensor electrodes 210 are configured as receiver electrodes and sensor electrodes 220 are configured as transmitter electrodes. In other embodiments, sensor electrodes 210 are configured to sense object position and/or motion in a first direction and sensor electrodes 220 are configured to sense object position and/or motion in a second direction.

Sensor electrodes 210 and 220 are typically ohmically isolated from each other. That is, one or more insulators separate sensor electrodes 210 and 220 and prevent them from electrically shorting to each other. In some embodiments, sensor electrodes 210 and 220 are separated by insulative material disposed between them at cross-over areas; in such constructions, the sensor electrodes 210 and/or sensor electrodes 220 may be formed with jumpers connecting different portions of the same electrode. In some embodiments, sensor electrodes 210 and 220 are separated by one or more layers of insulative material. In some other embodiments, sensor electrodes 210 and 220 are separated by one or more substrates; for example, they may be disposed on opposite sides of the same substrate, or on different substrates that are laminated together. The capacitive coupling between the transmitter electrodes and receiver electrodes change with the proximity and motion of input objects in the sensing region associated with the transmitter electrodes and receiver electrodes.

In some embodiments, the sensor pattern is “scanned” to determine these capacitive couplings. That is, the transmitter electrodes are driven to transmit transmitter signals. Transmitters may be operated such that one transmitter electrode transmits at one time, or multiple transmitter electrodes transmit at the same time. Where multiple transmitter electrodes transmit simultaneously, these multiple transmitter electrodes may transmit the same transmitter signal and effectively produce an effectively larger transmitter electrode, or these multiple transmitter electrodes may transmit different transmitter signals. For example, as described in further detail below, multiple transmitter electrodes may transmit different transmitter signals according to one or more coding schemes that enable their combined effects on the resulting signals of receiver electrodes to be independently determined.

The receiver sensor electrodes may be operated singly or multiply to acquire resulting signals. The resulting signals may be used to determine measurements of the capacitive couplings. A set of measured values from the capacitive pixels form a “capacitive image” (also “capacitive frame”) representative of the capacitive couplings at the pixels. Multiple capacitive images may be acquired over multiple time periods, and differences between them used to derive information about input in the sensing region. For example, successive capacitive images acquired over successive periods of time can be used to track the motion(s) of one or more input objects entering, exiting, and within the sensing region.

Referring again to FIG. 1, a processing system 110 is shown as part of the input device 100. The processing system 110 is configured to operate the hardware of the input device 100 (including, for example, the various sensor electrodes 200 of FIG. 2) to detect input in the sensing region 120. The processing system 110 comprises parts of or all of one or more integrated circuits (ICs) and/or other circuitry components. For example, as described in further detail below, a processing system for a mutual capacitance sensor device may comprise transmitter module configured to transmit signals with transmitter sensor electrodes, and/or receiver module configured to receive signals with receiver sensor electrodes).

In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like. In one embodiment, processing system 110 includes a determination module configured to determine positional information for an input device based on the measurement.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

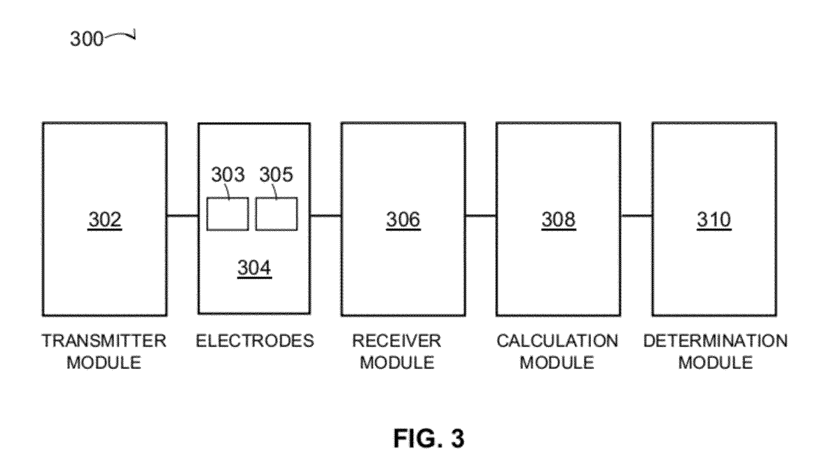

Referring now to the conceptual block diagram depicted in FIG. 3, an exemplary device 300 in accordance with various embodiments of the present invention will now be described. As illustrated, device 300 generally includes transmitter module 302 communicatively coupled via a set of electrodes (or simply “electrodes”) 305 to receiver module 306. Receiver module 306 may be coupled to calculation module 308, which itself may be coupled to determination module 310. In one embodiment, transmitter module 302 comprises transmitter circuitry. In one embodiment, receiver module 306 comprises receiver circuitry. Electrodes 304 include one or more transmitter electrodes 303 and one or more receiver electrodes 305. In one embodiment, for example, transmitter electrodes 303 and receiver electrodes 305 are implemented as described above in connection with FIG. 2.

Transmitter module 302 includes any combination of hardware and/or software configured to transmit transmitter signals to transmitter electrodes 303. Transmitter signals may be sinusoidal, square, sawtooth, triangle or any other type of wave form. Similarly, receiver module 306 includes any combination of hardware and/or software configured to receive resulting signals with receiver electrodes 305. As described above, a resulting signal will generally comprise effects corresponding to one or more transmitter signals transmitted with transmitter electrodes 303, and/or to one or more sources of environmental interference and/or internally generated noise.

In accordance with one embodiment of the present invention, each transmitter signal transmitted with transmitter electrodes 303 includes a plurality of sensing cycles, each corresponding to a respective bit within a bit sequence of a digital code (or, without loss of generality, a “spreading” code) as described in further detail below. In a particular embodiment, each transmitter signal includes a measurement interval and a polarity reset interval selected, for example, such that any transient response corresponding to a polarity reversal of the resulting signal substantially settles prior to the next measurement interval.

Calculation module 308 includes any combination of hardware and/or software configured to acquire a measurement of a change in capacitive coupling between transmitter electrode 303 and receiver electrode 305 based on the resulting signals received by receiver module 306. In one embodiment, for example, a change in capacitive coupling is acquired by deconvolving (or de-spreading) the resulting signals or signal received from receiver module 306. In one embodiment, the deconvolving can occur through correlation with the same or substantially the same digital code used to produce the transmitter signal. In embodiments comprising multiple, simultaneously transmitted transmitter signals, the resulting signal can deconvolve by correlation. In embodiments where there are as many receiver electrodes as transmitter electrodes being transmitted, the deconvolving can alternatively be accomplished by solving a set of equations that represent the resulting signal received with each receiver electrode as a linear combination of the transmitter signal transmitted with each transmitter electrode.

Determination module 310 includes any combination of hardware and/or software configured to determine positional information for an input device (e.g., as illustrated in FIG. 1) based on the measurement of change in capacitive coupling acquired by calculation module 308.

Having thus given an overview of exemplary device 300, a more detailed discussion of the nature of the transmitter signals sent to transmitter electrodes 303 and the resulting signals received by receiver electrodes 305 will now be presented. As mentioned briefly above, in accordance with one embodiment of the present invention, the transmitter signals each include a plurality of sensing cycles, wherein each of the sensing cycles includes a measurement interval and a polarity reset interval, and wherein the polarity of each sensing cycle corresponds to a respective bit within a spreading code.

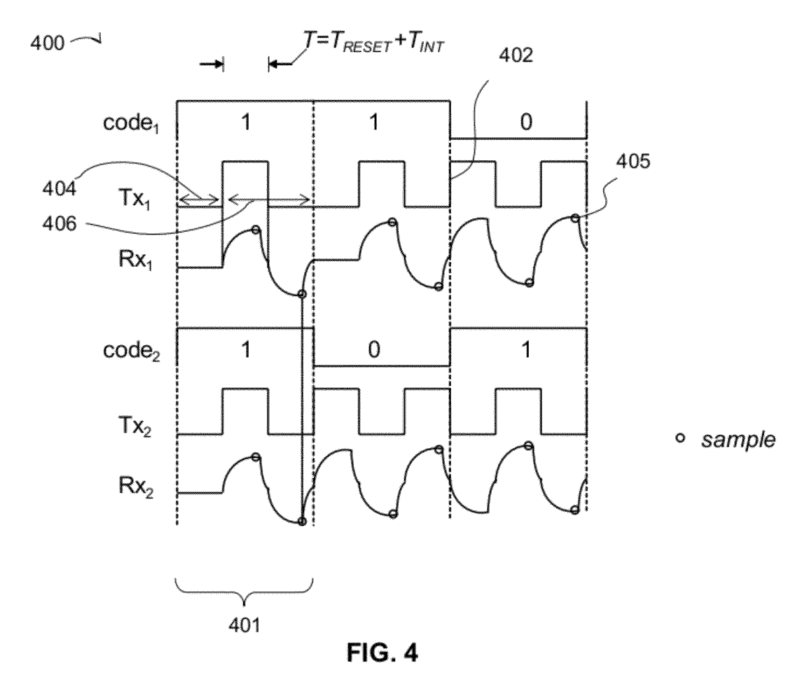

FIG. 4 illustrates a timing diagram 400 in accordance with one embodiment of the present invention, and is intended to depict the relationship between spreading code sequences, transmitted signals (from transmitter module 302), and resulting signals received by receiver module 306. Transmitter signals associated with two transmitter electrodes are illustrated: a first transmitter signal Tx₁, a first spreading code₁ sequence, and a resulting signal Rx₁, as well as a second transmitter signal Tx₂, a resulting signal Rx₂, and a second spreading code₂ sequence. In one embodiment the first transmitter signal and the second transmitter signal may be simultaneously transmitted with two transmitter electrodes. In another embodiment, the first transmitter signal and the second transmitter signal may be transmitted at different times with two transmitter electrodes. It will be appreciated that FIG. 4 is not necessarily drawn to scale, either in terms of amplitude or time scale. Further, while FIG. 4 depicts only two transmitter signals and two resulting signals, the present invention comprehends any number of such signals. While FIG. 4 depicts two transmitter signals, in other embodiments, a other embodiments may include a single transmitter signal, transmitted with a single transmitter electrode. In further embodiments, more than two transmitter signals are transmitted with a plurality of transmitter electrodes.

For the purpose of the example shown in FIG. 4, the spreading code sequence for code₁ is demonstrated as “110”, and the spreading code sequence for code₂ is demonstrated as “101.” Code₁ and code₂ are mapped to Tx₁ and Tx₂ as illustrated, such that each bit of the spreading code sequence corresponds to a respective transmitter signal during a sensing cycle 401. That is, the polarity of each sensing cycle 401 corresponds to a respective bit within a bit sequence of the spreading code sequence. Each transmitter signal undergoes reversals of polarity due to the change of its mapped spreading code from a “0” to a “1”, or from a “1” to a “0”. For example, at time 402 it can be seen that code₁ changes from a “1” to a “0”, and consequently resulting signal Rx₁ exhibits a transient response as it accommodates the change in polarity.

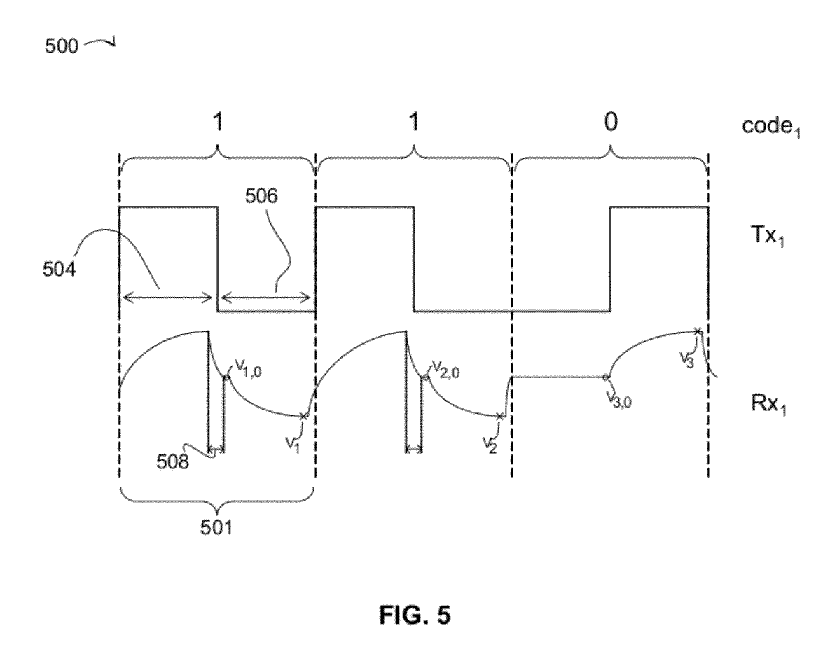

In the illustrated embodiment, sensing cycle 401 includes a polarity reset interval 404 and a measurement interval 406. In the embodiment shown in FIG. 4, the measurement interval 406 comprises two voltage transitions, where a sample is produced for each voltage transition. In other embodiments, the measurement interval may comprise more than two voltage transitions. In other embodiment, the measurement interval may comprise less than two voltage transitions. For example, in the embodiment of FIG. 5, the measurement interval comprises only a single voltage transition. Polarity reset interval 404 is preferably selected such that it is of sufficient duration to substantially accommodate the resulting signal transient due to the reversal of polarity of transmitted signal Tx₁ (e.g., at 402) due to the change of code₁ from a “1” to a “0”, or from a “0” to a “1”. That is, any transient response corresponding to a polarity reversal of the resulting signal Rx₁ is allowed to substantially settle prior to measurement interval 406, which provides for the resulting signals to be sampled during two half-cycles, as shown. Open circles (e.g., at point 405) depict the points at which the Rx signals Rx₁ and Rx₂ are sampled. In one embodiment, a measurement reset may be utilized to reset receiver module 306 and/or corresponding circuitry. The measurement reset may occur prior to or after a measurement interval.

In various embodiments, the number of samples produced may be different than the number of voltage transitions comprised by the measurement interval. For example, if the measurement interval comprises two voltage transitions, more than two samples may be produced.

In one embodiment, each sensing cycle 401 includes three measurement resets and two sample points 405. In other embodiments, other numbers of measurement resets and sampling points may be used. Thus, if the settling time for any given electrode is assumed to be T_{INT}, and the measurement reset time is assumed to be T_{RESET}, then each portion of sensing cycle 401 is of duration T=T_{RESET}+T_{INT}. Thus the polarity reset interval is of duration T and the measurement interval is of duration 2T. In one embodiment, polarity reset interval 404 has a duration less than T. For example, the polarity reset interval could be of length T_{INT} and the receiver module could be reset during this interval. In various embodiments, polarity reset interval 404 may not be constrained to be equal to T.

Referring again to FIG. 3 in conjunction with FIG. 4, in one embodiment, the resulting signals received by receiver module 206 can be modeled as the sum of the transmitted signals from transmitter module 302, which for convenience may be referred to herein as Tx₀, . . . Tx_{N}, multiplied by amplitudes proportional to the capacitances of the corresponding “pixels” associated with an image sensed via electrodes 304. More particularly, the received signal at receiver Rxⱼ, νⱼ(k), is a function of the transmitted spreading code, and may be represented as:

$${υ}_{j} ( 2 k ) = {\sum }_{i = 0}^{{Tx}_{n - 1}} {β}_{i} {{p}_{i} ( k ) }^{``} {up}^{″} sample$$

$${υ}_{j} ( 2 k + 1 ) = - {\sum }_{i = 0}^{{Tx}_{n - 1}} {β}_{i} {{p}_{i} ( k ) }^{``} {down}^{″} sample$$

where the magnitude (or “output”) βᵢ is proportional to the capacitance between transmitter TXᵢ and receiver RXⱼ, pᵢ(k=0 . . . M−1) is the spreading code sequence transmitted by transmitter TXᵢ, and k=0 . . . M−1, represents the M time domain samples spanning the length of a spreading code sequence. In one embodiment, a composite (or demodulated) resulting signal is formed by subtracting the “up” and “down” samples of each interval to produce,

rⱼ(k)=νⱼ(2k)−νⱼ(2k+1)

In one embodiment, deconvolving may comprise correlating an estimation of each magnitude βᵢ (e.g., by calculation module 308) involves with the resulting signal Rxⱼ with the spreading code sequence for each transmitter signal Txᵢ, summing the result, and normalizing the output by a cross-correlation gain. This implementation may be characterized by:

$${\hat{β}}_{i} = \frac{1}{γ} {\sum }_{k = 0}^{M - 1} {r}_{j} ( k ) {p}_{i} ( k )$$

where \hat{β}ᵢ is the estimated magnitude of the capacitance between Txᵢ and Rxⱼ, and γ is a normalization factor dependent on the correlation output of the sum of all spreading code sequences. For instance, in one embodiment, γ=M where M is the length of the spreading code. Normalization is convenient but not necessary.

In accordance with an alternate embodiment, deconvolving may comprise an estimation of the magnitudes of the capacitances utilizing maximum-likelihood (ML) detection or sequential/iterative decoding. Such techniques are particularly applicable in cases where the processing system has prior knowledge regarding noise and/or interference characteristics of the system. ML detection maximizes the probability of receiving the received signal by searching over all possible NTx tuples of the magnitudes, i.e.:

$$arg {max}_{{\hat{β}}_{0} , {\hat{β}}_{1} , … , {\hat{β}}_{Ntx - 1} ∈ B} = P ( {r}_{j , 0} , {r}_{j , 1} , … , {r}_{j , M - 1} \vert {\hat{β}}_{0} , {\hat{β}}_{1} , … , {\hat{β}}_{Ntx - 1} )$$

where B in NTx dimensional space represents the set of all valid NTx tuple magnitudes. In the case of additive white Gaussian noise (AWGN) the probability given by this relation is maximized by minimizing the Euclidean distance between the received vector and the set of expected received vectors, in the absence of noise corresponding to the candidate magnitude sets. If there are two possible magnitudes representing the capacitances of the “no object present” and the “object present” cases, then there are a total of 2NTx Euclidean distance measures to be calculated. The set that results in the minimum Euclidean distance represents the set of detected magnitudes.

FIG. 5 depicts an alternate timing diagram 500 that implements a double correlated sampling technique. As with FIG. 4, a spreading code sequence code₁ (in this case “110”) is mapped to transmitter signal Tx₁. Unlike FIG. 4, however, the sensing cycle 501 is partitioned into only two intervals: a polarity reset interval 504, followed by a measurement interval 506. In this embodiment, intermediate samples (e.g., V_{1,0} and V_{2,0}) are taken at a predetermined time period (e.g., 508) after each amplifier reset. Further, a sample (S) is taken before the subsequent transition of the transmitter signal (e.g., at V₁, V₂). Thus, sample S₁=−(V₁−V_{1,0}), sample S₂=−(V₂−V_{2,0}), and sample S₃=(V₃−V_{3,0}). In various embodiments, the double correlated sampling technique may be applied to a measurement interval having multiple voltage transitions. In further embodiment, various different sampling techniques can be applied to the measurement intervals to produce a number of samples different from the number of voltage transitions comprised by the measurement interval. In various examples, the number of samples produced may be greater than the number of voltage transitions comprised by the measurement interval.

A variety of spreading codes may be used in connection with the present invention. In one embodiment, for example, the spreading codes for the set of transmitters Tx_{N} are substantially orthogonal—i.e., exhibit very low cross-correlation, as is known in the art. Note that two codes may be considered substantially orthogonal even when those codes do not exhibit strict, zero cross-correlation. In a particular embodiment, for example, the spreading codes are pseudo-random sequence codes. In other embodiments, Walsh codes, Gold codes, or another appropriate quasi-orthogonal or orthogonal codes are used. If narrowband noise is significant, certain spreading code sequences (based on the spectral characteristics) may be more immune to the narrowband noise than other sequences. In such cases, demodulation can proceed by estimation of the magnitudes corresponding to those identified spreading code sequences, and then subtracting the contribution of the corresponding transmitted signals from the received signal before proceeding to the demodulation of the signals that are more susceptible to the narrowband noise.

Thus, the embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

1. A processing system for an input device, the processing system comprising:
transmitter module comprising transmitter circuitry, the transmitter module configured to transmit a first transmitter signal with a first transmitter electrode, wherein the first transmitter signal comprises a first plurality of sensing cycles, the polarity of each sensing cycle of the first plurality of sensing cycles corresponds to a respective bit within a bit sequence of a first spreading code, and wherein each sensing cycle of the first plurality of sensing cycles comprises a measurement interval and a polarity reset interval; and
receiver module comprising receiver circuitry, the receiver module configured to receive a resulting signal with a receiver electrode, wherein the resulting signal comprises effects corresponding to the first transmitter signal.

2. The processing system of claim 1, wherein, during the polarity reset interval, a transient response corresponding to a polarity reversal of the resulting signal substantially settles prior to the measurement interval.

3. The processing system of claim 1, wherein the receiver circuitry is configured to receive the resulting signal during the measurement interval.

4. The processing system of claim 1, wherein:
a sensing cycle of the first plurality of sensing cycles has a period;
a polarity reset interval of the sensing cycle lasts for a first duration of the period; and
a measurement interval of the sensing cycle lasts for a second duration of the period, wherein the second duration is longer than the first duration.

5. The processing system of claim 1, wherein the transmitter module is further configured to transmit a second transmitter signal with a second transmitter electrode, wherein the second transmitter signal comprises a second plurality of sensing cycles, the polarity of each sensing cycle of the second plurality of sensing cycles corresponds to a respective bit within a bit sequence of a second spreading code, and each sensing cycle of the second plurality of sensing cycles comprises a measurement interval and a polarity reset interval, and wherein the first transmitter signal and second transmitter signal are simultaneously transmitted.

6. The processing system of claim 5, wherein the first spreading code and the second spreading code are substantially orthogonal.

7. The processing system of claim 5, wherein the first spreading code and the second spreading code are pseudo-random sequences codes.

8. The processing system of claim 1, wherein the processing system further comprises:
calculation module configured to acquire a measurement of a change in capacitive coupling between the first transmitter electrode and the receiver electrode, the measurement based on the resulting signal; and
determination module configured to determine positional information for an input device based on the measurement.

9. The processing system of claim 5, wherein the resulting signal further comprises effects corresponding to the second transmitter signal, and wherein the processing system further comprises:
calculation module configured to acquire a measurement of a change in capacitive coupling between the first transmitter electrode and the receiver electrode and between the second transmitter electrode and the receiver electrode by deconvolving the resulting signal based on the first and second spreading codes; and
determination module configured to determine positional information for an input device based on the measurement.

10. A method of capacitive sensing, the method comprising:
transmitting a first transmitter signal with a first transmitter electrode, the first transmitter signal comprising a first plurality of sensing cycles; and
receiving a resulting signal with a receiver electrode, wherein the resulting signal comprises effects corresponding to the first transmitter signal;
wherein the polarity of each sensing cycle of the first plurality of sensing cycles corresponds to a respective bit within a bit sequence of a first spreading code; and
wherein each sensing cycle of the first plurality of sensing cycles comprises a measurement interval and a polarity reset interval.

11. The method of claim 10, wherein, during the polarity reset interval, a transient response corresponding to a polarity reversal of the resulting signal substantially settles prior to the measurement interval.

12. The method of claim 10, wherein:
a sensing cycle of the first plurality of sensing cycles has a period;
a polarity reset interval of the sensing cycle lasts for a first duration of the period; and
a measurement interval of the sensing cycle for a second duration of the period, wherein the second duration is longer than the first duration.

13. The method of claim 10, further comprising:
transmitting a second transmitter signal with a second transmitter electrode, the second transmitter signal comprising a second plurality of sensing cycles;
wherein the polarity of each sensing cycle of the second plurality of sensing cycles corresponds to a respective bit within a bit sequence of a second spreading code;
wherein each sensing cycle of the second plurality of sensing cycles comprises a measurement interval and a polarity reset interval; and
wherein the first transmitter signal and the second transmitter signal are simultaneously transmitted.

14. The method of claim 13, wherein the first spreading code and the second spreading code are substantially orthogonal.

15. The method of claim 13, wherein the resulting signal further comprises effects corresponding to the second transmitter signal, and wherein the method further comprises:
acquiring a measurement of a change in capacitive coupling between the first transmitter electrode and the receiver electrode and between the second transmitter electrode and the receiver electrode by deconvolving the resulting signal based on the first and second spreading codes; and
determining positional information for an input device based on the measurement.

16. A capacitive sensor device comprising:
a first transmitter electrode;
a receiver electrode; and
a processing system communicatively coupled to the first transmitter electrode and receiver electrode, the processing system configured to:
transmit a first transmitter signal with the first transmitter electrode, wherein the first transmitter signal comprises a first plurality of sensing cycles, the polarity of each of the first plurality of sensing cycles corresponds to a respective bit within a bit sequence of a first spreading code, and each of the first plurality of sensing cycles comprises a measurement interval and a polarity reset interval; and
receive a resulting signal with the receiver electrode, wherein the resulting signal comprises effects corresponding to the first transmitter signal.

17. The capacitive sensor device of claim 16, wherein, during the polarity reset interval, a transient response corresponding to a polarity reversal of the resulting signal substantially settles prior to the measurement interval.

18. The capacitive sensor device of claim 16, wherein:
a sensing cycle of the first plurality of sensing cycles has a period;
a polarity reset interval of the sensing cycle lasts for a first duration of the period; and
a measurement interval of the sensing cycle lasts for a second duration of the period, wherein the second duration is longer than the first duration.

19. The capacitive sensor device of claim 16, further comprising:
a second transmitter electrode;
wherein the processing system is configured to transmit a second transmitter signal with the second transmitter electrode while simultaneously transmitting the first transmitter signal; and
wherein the second transmitter signal comprises a second plurality of sensing cycles, the polarity of each sensing cycle of the second plurality of sensing cycles corresponds to a respective bit within a bit sequence of a second spreading code, and each sensing cycle of the second plurality of sensing cycles comprises a measurement interval and a polarity reset interval.

20. The capacitive sensor device of claim 19, wherein the first spreading code and the second spreading code are substantially orthogonal.
